(19) United States
(12) Patent Application Publication
(10) Pub. No.: US 2008/0083220 A1
(43) Pub. Date: Apr. 10, 2008

(54) Space heating and cooling system having a co-generator drive a geothermal, connected heat pump

(76) Inventor: Daniel Shichman, Trumbuli, CT (US)

Correspondence Address: Daniel Shichman, 20 Copper Kettle Rd., Trumbull, CT, 06611, US

(21) Appl. No.: 11/544,434

(22) Filed: Oct. 6, 2006

(51) Int. Cl. F03G 7/00

(52) U.S. Cl. 60/641.2

(57) ABSTRACT

A system and method are described for providing space heating and cooling along with tap water heating by combining the use of co-generation and a geothermal connected heat pump. The use of energy storage allows the intermittent use and extended life of the co-generator engine. These combinations provide marked energy savings and emissions reduction as compared to direct combustion and grid connected geothermal heat pump systems,

This application is a continuation-in-part of U.S. patent application Ser. No. 10/943,468 and includes portions of that application.

### BACKGROUND OF THE INVENTION

Solar energy, geothermal/heat pump and co-generation of electricity have all been used to beneficial effect but each approach has major limitations for general US use. Solar either in the form of heat or electricity is costly and is severely limited for use in northern latitudes, e.g. New England.

Geothermal for heating/cooling which is normally combined with heat pumps is also limited by latitude, but does not show major cost savings. This is because the system depends on electricity from the power grid to drive or supplement the heat pump. If the system has a COP(coefficient of performance) of e.g. 3 or a 67% btu savings, which is attractive, but it fails to meet actual cost savings because the electrical power/grid system approaches 30% net btu efficiency. In addition the electrical grid is stretched to the limit. It is worth noting that geothermal energy is a form of solar energy storage and can be useful at northern latitudes.

Co-generation or the use of waste heat normally discarded at power plants is useful in cities and even large office buildings etc. Generally the investment required is large and the application for suburban use is limited. Small water cooled IC (internal combustion) engines can produce distributed power as disclosed in U.S. Pat. No. 4,510,756 with the waste heat applied to home use. However these engines cannot be considered for continuous use. These engines are available to operate with oil, gasoline, natural gas, propane or even hydrogen.

### SUMMARY OF THE INVENTION

This invention defines means to combine the features and savings of GHP (geothermal/heat pump) and co-generation in a useful way so as to achieve attractive ROI (return on investment). The ROI is achieved primarily by energy savings but also With marked reductions in combustion emissions in the overall power generating system. The following patents describe typical prior art:

U.S. Pat. No. 2,266,238 describes means to drive a reversible heat pump system with a co-generator and alternate between heating or air conditioning. No use is made of geothermal energy to increase efficiency or providing means to extend the life of the co-generator.

U.S. Pat. No. 2,076,382 describes the use of co-generation with waste heat used locally to achieve a 50% reduction in fuel use. No use of GHP or means to extend the life of the co-generator are described.

U.S. Pat. No. 3,678,284 describes periodic use of co-generation with waste heat utilized for water heating and HVAC (heating and air conditioning) purposes. No use of GHP and relies on interfacing with the electrical grid which can add associated costs.

U.S. Pat. No. 3,944,837 describes distributed co-generators supplying electricity to the power grid and utilizing the waste heat locally. No use of GHP or means to extend the life of the co-generators is described.

U.S. Pat. No. 3,259,317 describes the use of a heat pump with co-generation and optional braking load where the waste heat is used locally. The braking load is used at low ambient temperatures when the heat pump/co-generator system use is not efficient. Geothermal use or means to extend the life of the co-generator are not included.

The combination of co-generation with GHP as described in this disclosure can result in approximately 55% to 65% overall fuel savings and reduction in combustion emissions. To make this goal achievable it is also necessary to make co-generation practical by minimizing the engine of the co-generator use time by incorporating at least two appropriate heat storage tanks. The beneficial contributions of GHP also contribute to reducing the time required for co-generator use.

One storage tank is designed to receive energy from the heat pump at a temperature suitable for its efficient operation e.g. 100 to 110 deg, F. in the heating mode. In the cooling mode this may be set for example at 40 deg. F.

The other tank is set to receive waste or cooling heat from the engine driving the generator e.g. 180 deg. F. Both tanks are used to receive energy and distribute energy to the building being serviced. The Detailed Description describes how this is accomplished for operation in the heating season mode and then for the cooling AC (air conditioning) mode.

Distribution modes to effectively use the energy from the two storage tanks are described. To support the understanding of this invention, examples and description of the involved heat pump are given.

### DESCRIPTION OF DRAWINGS

FIG. 1 show three modes of energy consumption for air conditioning.

FIG. 2 shows three modes of energy consumption for space heating.

FIG. 3 is an engineering schematic drawing describing the elements of this invention in the air conditioning mode. FIG. 3A is flow schematic showing a set of conditions within the heat pump shown in FIG. 3. FIG. 3B shows a modification of FIG. 3 where refrigerant circulation from the heat pump flows thru a storage tank eliminating the need for certain components.

FIG. 4 is an engineering schematic drawing describing the elements of this invention in the space heating mode. FIG. 4A is a flow schematic showing a set of conditions within the heat pump shown in FIG. 4. FIG. 4B shows a modification of FIG. 4 where refrigerant from the heat pump is directed thru a storage tank eliminating the need for certain components.

FIG. 5 is an engineering schematic showing one possible arrangement of storage drums and the contained heat transfer elements, and how the flow can be arranged for the heating season (FIG. 5A) and for air conditioning(FIG. 5B). Having the flow change from as shown in FIG. 5A to FIG. 5B achieves the seasonal reversal of the heat pump.

### DETAILED DESCRIPTION OF INVENTION

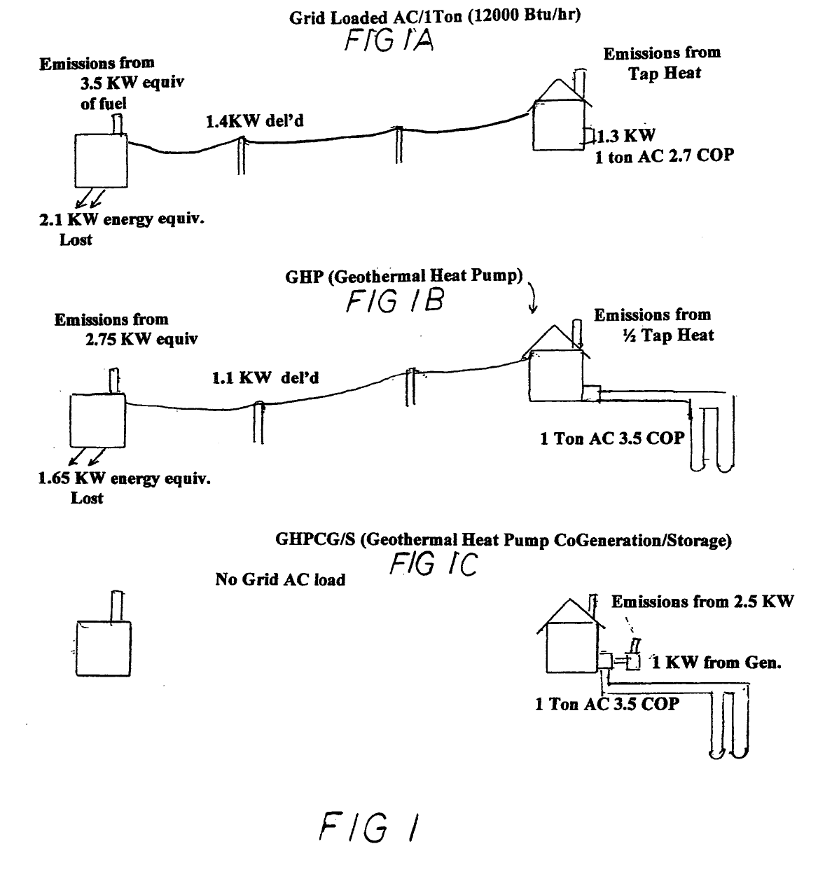

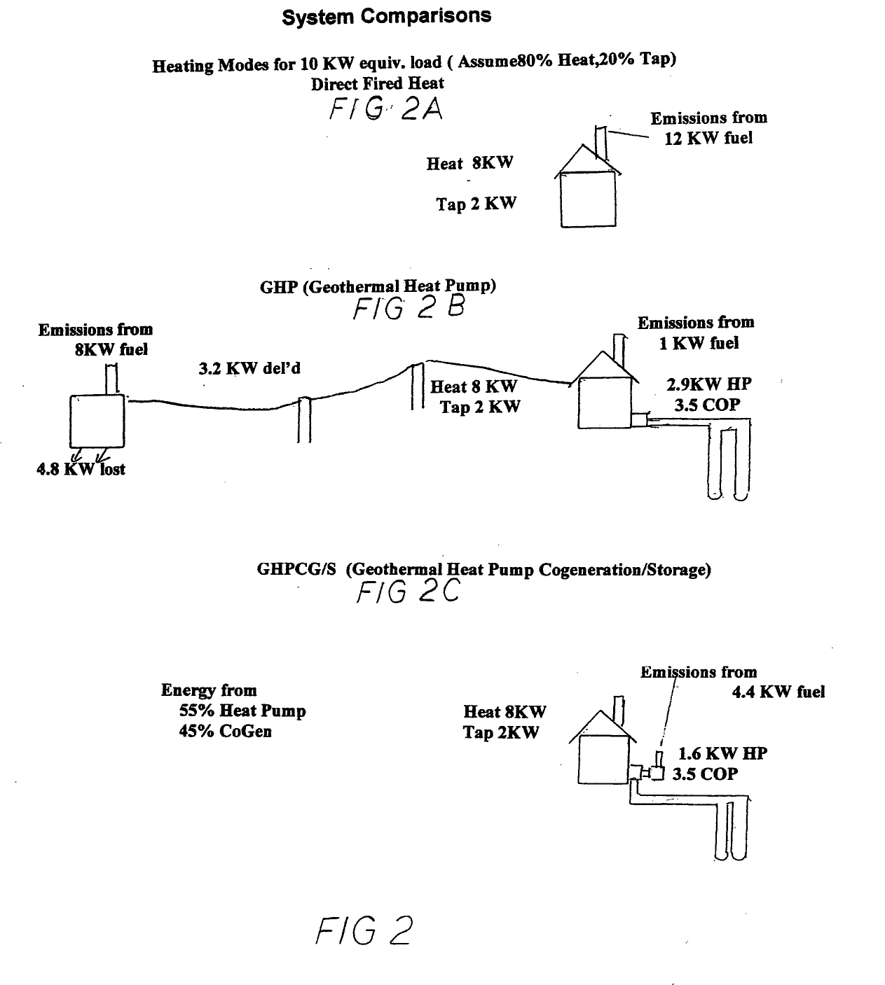

FIGS. 1 and 2 show typical energy consumption and emissions for the utility/customer system. FIG. 1 is for the air conditioning season and FIG. 2 covers the heating season.

In both FIGS. 1C and 2C describe the energy savings along with the emissions reduction possible by applying the principles of this invention.

FIG. 1A shows a presently national typical connection to a fuel fired utility to deliver electricity to drive a 1 ton air conditioner operating at a 2.7 COP(coefficient of Performance). The customer requires 1.3 KW of power and has emissions only from a fuel fired tap hot water heater. The utility delivers about 1.4 KW because of grid losses and burns the energy equivalent of 3.5 KW of fuel to generate the 1.4 KW. The losses are typical of power generating efficiencies.

FIG. 1B shows a typical GHP (geothermal/heat pump) installation delivering 1 ton of air conditioning. The COP is typically 3.5 and is more efficient because of the lower rejection heat or condenser temperature that is made available from the ground water loop. It is assumed that some waste heat of the heat pump can be recovered for hot water tap use and thus emissions are reduced as compared to FIG. 1A. Since waste heat of a heat pump is typically 110 F maximum, supplemental heat for typical 140 F tap water is required. To deliver the 1 KW of energy required approximately 1.1 KW of electricity must be generated by the utility to overcome grid losses. Emissions are reduced about 20% as compared to system 1A. This is accomplished though by depending upon the grid to deliver the driving energy. Several hundred thousand units are presently installed in the USA as compared to tens of millions of system 1A.

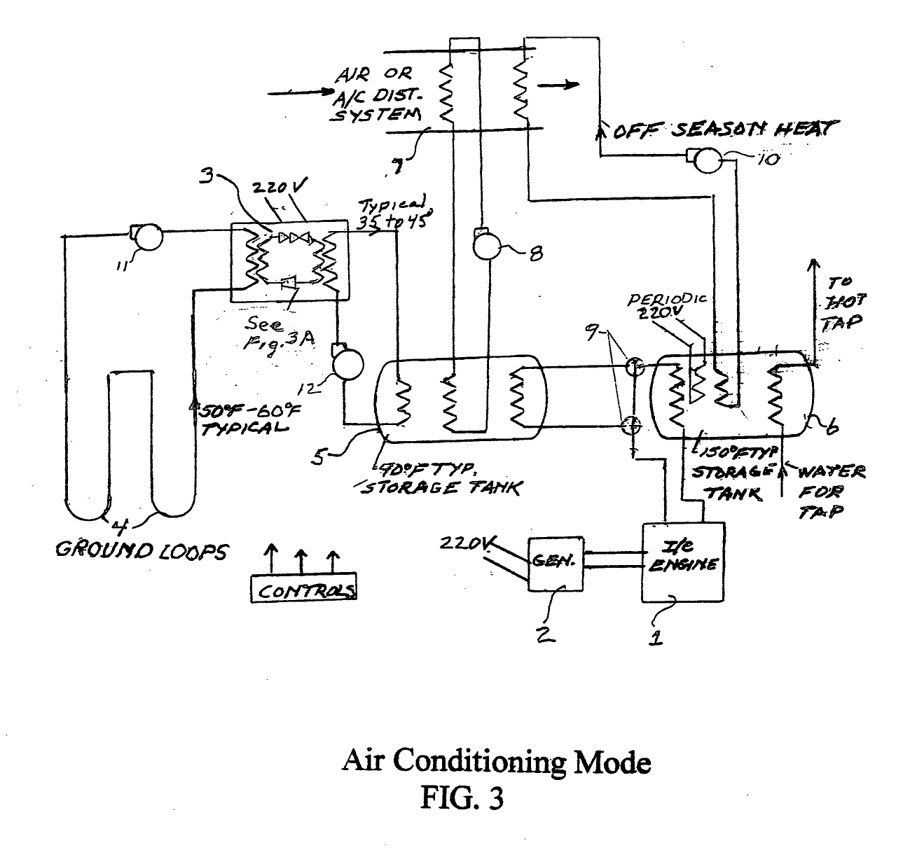

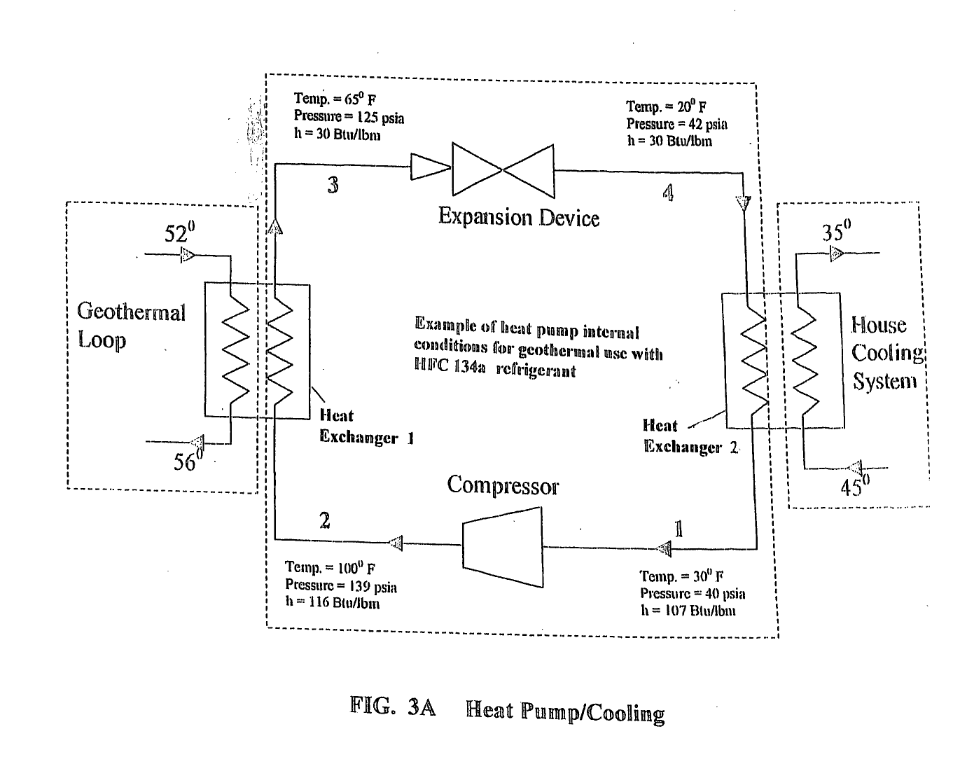

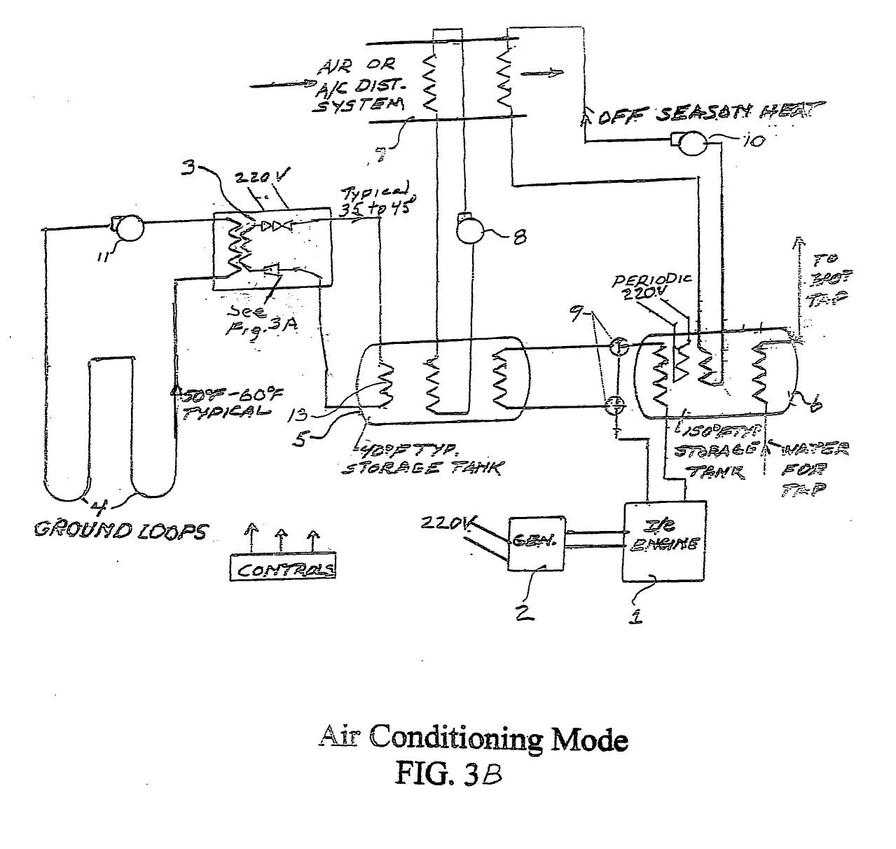

FIG. 1C shows the effect of applying the elements of this invention for example as shown in the schematic FIG. 3. In FIG. 1C 1 KW from the co-generator combined with a heat pump with geothermal loop (GHP) will provide 1 ton of air conditioning. This results in emissions from 2.5 KW energy equivalent of fuel. The emissions may be slightly less for diesel or slightly more for natural gas, propane or gasoline fired internal combustion (IC) engine. The schematic FIG. 3 includes 2 (hot and cold) water storage tanks which allows for intermittent operation of the co-generator and thus an acceptable engine life before major overhaul. Further use of these tanks follows in detailed description of FIG. 3. Referring back to FIG. 1C it is noted that the overall emissions are reduced as compared to FIGS. 1A and 1B, but more usefully the air conditioning grid load is eliminated.

Referring to FIG. 2A, a typical fuel fired heating system as shown to produce 10 KW energy equivalent of heating, of which 2 KW is for tap water heating and 8 KW for space heating. The emissions generated are from 12 KW fuel equivalent combustion.

FIG. 2B shows the utility/customer system for a GHP (geothermal heat pump) customer requiring 10 KW of heating energy equivalent. The customer recovers 50% of the heated tap water requirement from the heat pump but must purchase 2.9 KW of electricity from the utility. The customer generates 1 KW of energy combustion emissions and the utility 8 KW of fuel emissions. The grid is loaded with 3.2 KW of electricity for the customer. The overall emissions savings are significant e.g. 25% but the cost savings for the customer are not achieved because of the higher cost of electricity as compared to simple direct fired fuel heating systems.

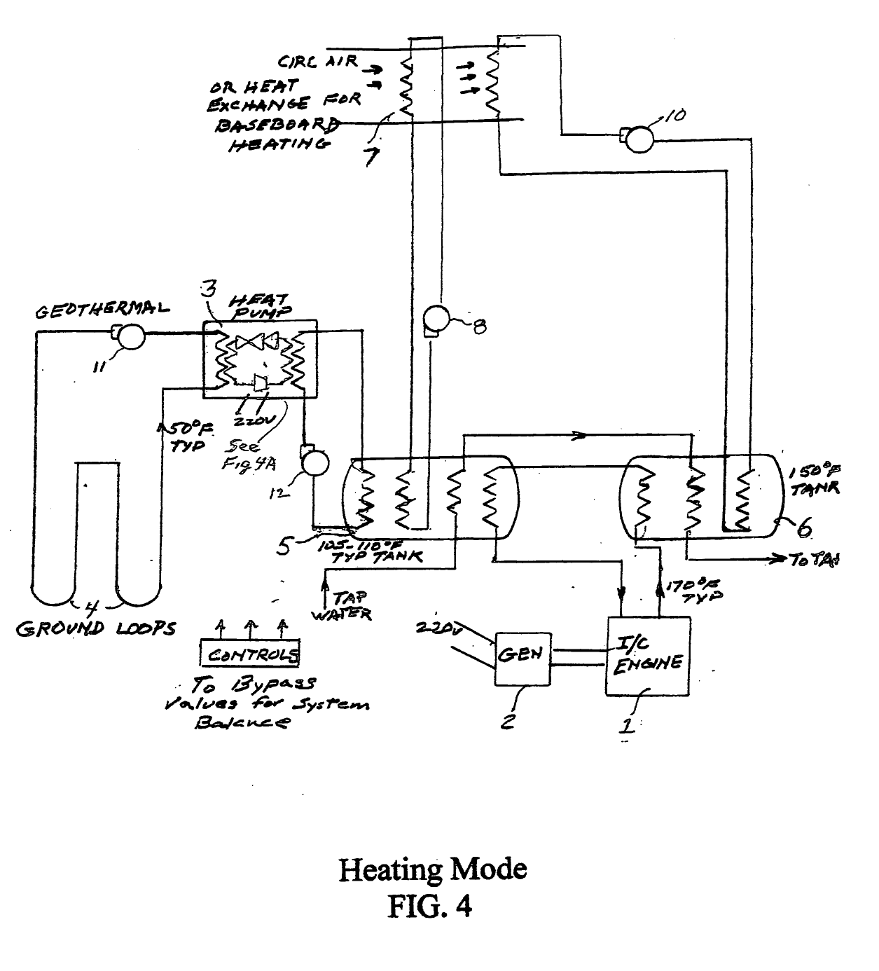

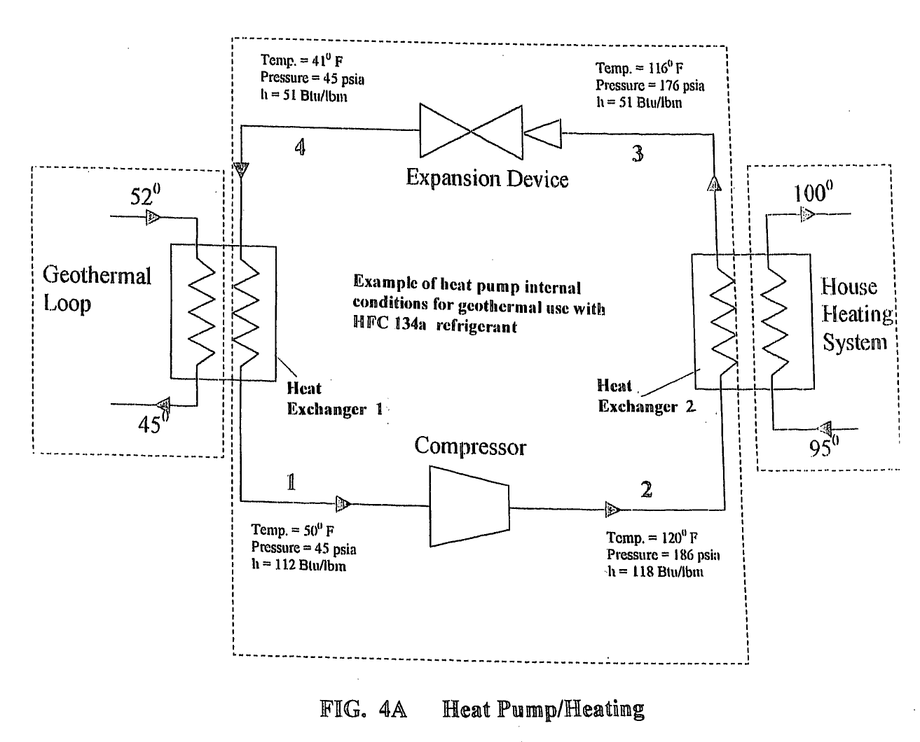

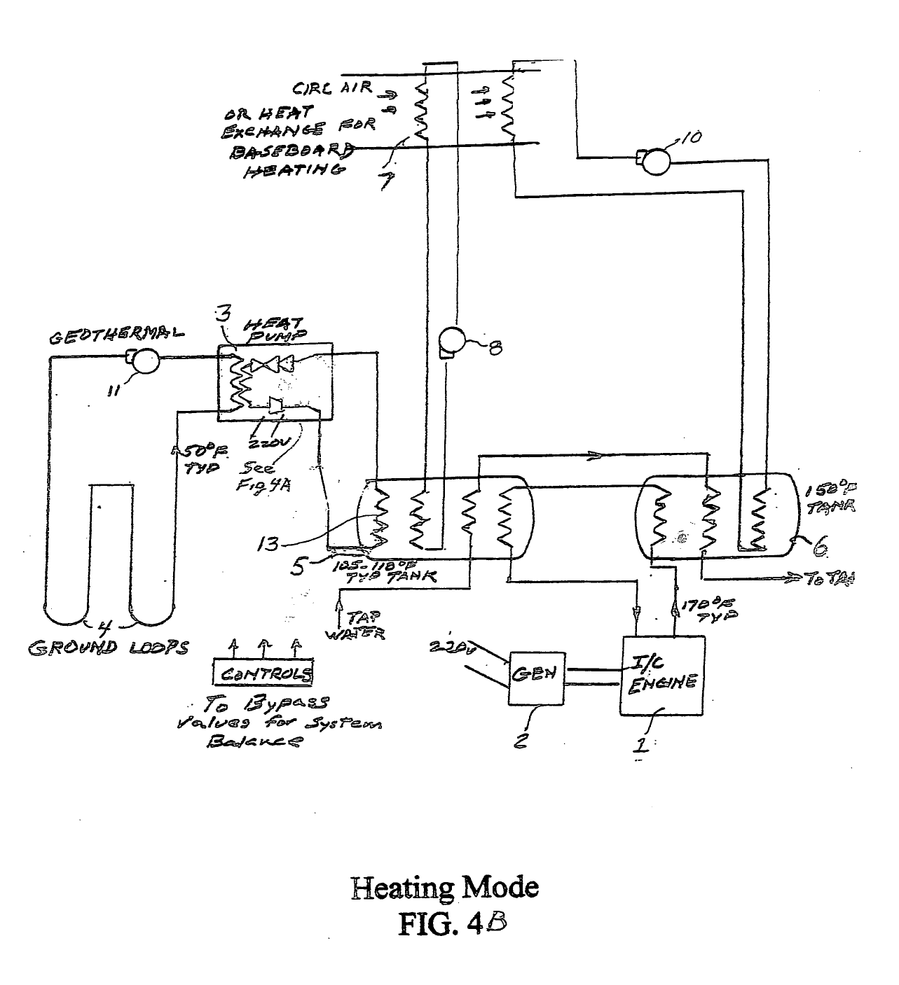

FIG. 2C shows the benefits of applying this invention to space heating. The engineering schematic FIG. 4 shows the components and typical piping arrangements. The GHP loop and co-generator each feed associated hot water storage tanks. The detail description of the functions and fluid flow is described for FIG. 4. FIG. 2C shows that space heating can be accomplished without reliance on the grid as compared to FIG. 2B. To produce 10 KW of energy requires approximately 4.4 KW of fuel combustion, approximately ½ of the GHP system of FIG. 2B and even greater fuel consumption reduction as compared to FIG. 2A.

FIGS. 3, 3A, 3B and 4, 4A, 4B give more detailed description of the air conditioning and heating modes.

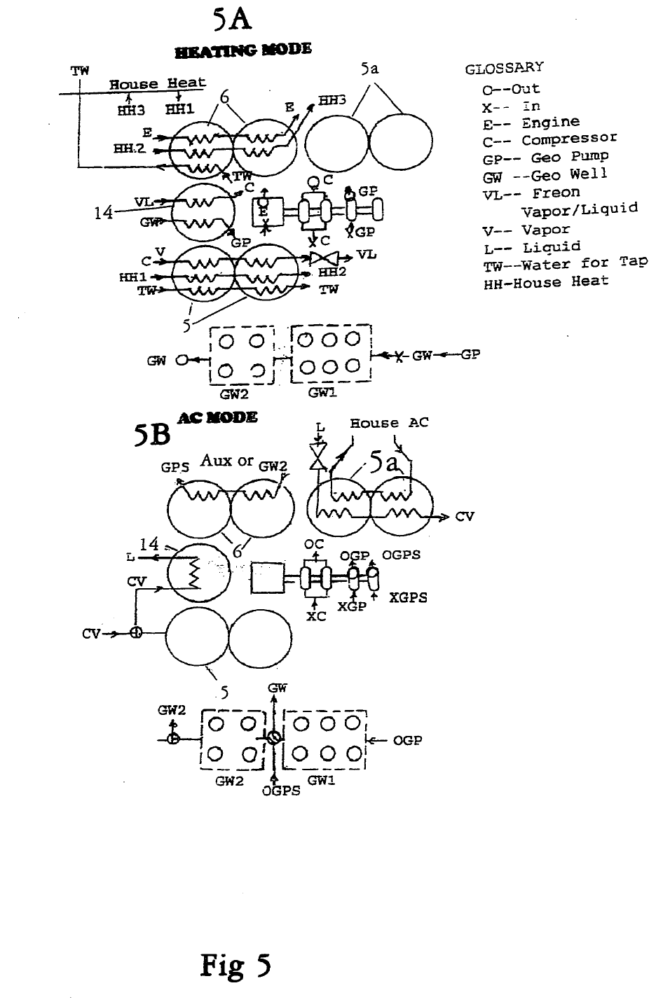

FIG. 3, the air conditioning mode, includes (1) an I/C (internal combustion engine) driving (2) an electric generator with the output power fed to (3) an electric driven heat pump. The heat pump rejects heat to pipes buried forming geothermal loops (4). The cold water output of the heat pump is circulated to heat transfer coils in storage tank (5) typically set to operate near 40 degrees F. Storage tank (6) typically set to operate at near 120 F, receives heat rejection water from I/C engine (1) which is circulated thru heat transfer coils within the tank. Three way valves (9) are shown as a means to direct water containing engine heat to storage tank (6). These valves can optionally direct heat to both storage tanks when storage tank (5) is used in a heating mode after a seasonal changeover. In the air conditioning mode the engine water is directed only to storage tank(6). These valves can be eliminated if the system includes extra tanks which can be dedicated so as not requiring a seasonal tank changeover. See description of FIG. 5 for a more complete example of achieving seasonal changeover. Cold water from coils within tank(5) is circulated to the space cooling/heating system (7). Hot water can be circulated from coils in tank (6) to the space cooling/heating system for optional off season heating. In-coming water for the hot water tap is heated by coils in tank (6). Circulating pumps are indicated by symbols (8) & (12).

FIG. 3 A gives further description of the elements and conditions within the heat pump shown in FIG. 3. A heat pump by definition takes heat from a low temperature at an evaporator and rejects the heat to a higher temperature at a condenser. A mechanically driven freon (refrigerant) heat pump is used by example to explain this invention. Such a heat pump consists of a driven compressor feeding its vapor output to a condenser shown here as Heat Exchanger (1), where the vapor is condensed to liquid. The pressurized liquid then flows to a pressure reducing expansion device after which the liquid and some vapor are evaporated in an evaporator shown here as Heat Exchanger (2). The vapor from the evaporator is then circulated back to the compressor. The fluid conditions shown by example are for refrigerant 134a. In the air conditioning mode the condenser faces the geothermal loop.

FIG. 3B shows by example how certain components of FIGS. 3A& 3B can be eliminated. Heat exchanger (2) of FIG. 3A and circulating pump (12) of FIG. 3 are eliminated by circulating the refrigerant to a coil (13), now the evaporator, in storage tank(5). The heat pump compressor provides the circulating energy.

FIG. 4, the heating mode includes (1) the I/C engine driving (2) an electric generator with the output power fed to (3) an electric driven heat pump. The heat pump draws water from the geothermal loops (4) to heat the cool or evaporator side of the heat pump. The warm water output side of the heat pump is circulated to heat transfer coils in storage tank (5). Storage tank (6) receives heat rejection from I/C engine (1) which is circulated thru heat transfer coils within the tank. Warm water from coils within tank (5) is circulated to heat transfer means for space heating (7). Hot water from coils in tank (6) is also circulated to heat transfer means in the space heating system. Each tank has its own specific circulation loop and the water loops are separated. Tap water for the hot water tap is heated first by coils in tank (5) then subsequently by coils in tank (6). Circulating pumps are indicated by symbols (8),(12).

FIG. 4A gives further description of the elements and conditions of the heat pump shown in FIG. 4. The heat pump is shown reversed as compared to FIG. 3A. Heat is now rejected at the condenser shown as Heat Exchanger 2 and absorbed at the evaporator shown as Heat exchanger (1). The compressor as is normal, feeds compressed vapor to the condenser, and then to the expansion device. Fluid from the expansion device then flows to the evaporator. In the heating mode, the condenser faces the home heating system. FIG. 4(B) shows how by example certain components of FIGS. 3, 3A can be eliminated. Heat Exchanger 2 and circulating pump (12) are eliminated by circulating refrigerant from the heat pump to a coil now the condenser in storage tank (5).

Seasonal flow change and heat pump reversal is shown for example in FIG. 5. FIG. 5A shows a possible arrangement for the system heating season mode. An I/C engine (E) is indicated driving two compressors and also two geothermal well circulating pumps,(GP) and (GPS). Water storage drums(eg 55 gal.) (5) and (6) form equivalent to storage tanks (5) and (6) in FIGS. 4 and 4B. Drum (14) primarily operates as a heat exchanger or evaporator (see heat exchanger 1 of FIG. 4A)of the heat pump. Heat is transferred from the geothermal fluid to the heat pump vapor/liquid refrigerant. See FIG. 4A. Water storage drums (5) contains heat exchange elements to transfer heat from the heat pump refrigerant and act as the system condenser (see heat exchanger 2 of FIG. 4A). Heat transferred to heat exchange elements so as to provide heat to house heating (HH) and tap water (TW). The geothermal well which may consist of a series of connected eg. 25 ft deep holes. Each hole containing a closed loop of piping. These holes are indicated schematically GW1 and GW2. Flow to and from the wells are indicated by GW.

Water storage drums(6) receives waste heat from the I/C engine and provides added heat for house heating (HH) and tap water (TW)

FIG. 5B indicates the changes in flow from FIG. 5A to achieve heat pump reversal and the air conditioning mode. In the AC(air conditioning) mode, the refrigerant heat exchange element in tank (14) by changes in not shown directional valves, now receives vapor from the compressor. The geothermal HE (heat exchange) element is not shown but is as shown in FIG. 5A with flow from Geo well GW to pump GP and provides cooling to the tank (14) which now functions as the AC condenser. See HE 1 in FIG. 3A. Tank (5) is now inoperative with flow to and from its HE elements shut off or directed otherwise. Tank (5A) which was similarly inoperative in the heating mode now has an active refrigerant HE element which receives refrigerant from the expansion device and delivers vapor to the compressor. The tank and its HE elements function as the evaporator. See HE 2 in FIG. 3A. Thru the included HE cooling is transferred to the house air handler etc.

Tank 6 of 5B has the same active HE elements as shown in (6) of 5 A. In addition it has an HE element that receives Geo thermal well or auxiliary cooling from an engine radiator. The purpose of this loop is to assist in controlling tank (6) temperature when tap the heating of tap water TW is not a sufficient cooling source to counter balance the engine heat. Added cooling can be provided by GW2 circulation from a portion of the geothermal well. Most of the other geothermal well circulation operates in a separate loop to provide cooling to tank (14).

The valves used to control flow direction are not shown in FIG. 5 schematic but can readily be applied having the above description of desired flow. It is also seen that the storage tanks provide an excellent means to insert heat exchange elements for heat exchange between multiple flow loops.

Operation of the System in A/C Mode:

The incorporation of geothermal loops increases the efficiency of the heat pump by providing a typical heat rejection temperature of 50 to 60 F as compared ambient air temperatures for normal air conditioning. The use of a cold water storage tank at 35 to 45 F allows for periodic use of the heat pump system. Since the heat pump is driven by the I/C engine generator, only periodic use of the I/C engine is required, thus markedly extending the use life before required maintenance and overhaul. For example 250 gal. can store nearly 20000 Btu of cooling potential when operating in a 10 F range. When the storage tank temperature increases above a set point e.g. 45 F the I/C co-generator is turned on to operate the heat pump and circulate water through the geothermal loops Cooling of the living space is controlled by normal thermostats to circulate cooling fluid to the space A/C distribution system. The waste heat of the I/C co-generator is collected in storage tank (6) and is used during the A/C season to primarily heat the domestic tap water. Space heating can also be provided as required by weather conditions. There may be periods when hot tap water use does not provide adequate cooling of the I/C engine and reversion to radiator or geothermal cooling of the engine may be called for by the controls. Other weather periods may occur when the GHP is arranged for cooling and no cooling is required, but tap water heating or supplementary heating is called for by the controls. To operate the co-generator with a load it is useful to connect the generator to a heating element positioned in the heat storage tank. This can avoid the need to reverse the GHP from cooling to heating mode and still operate the co-generator I/C engine properly under load.

FIG. 3A gives the refrigerant 134a conditions in the example heat pump. The temperature, pressure and enthalpy (h) allow for calculating unit design and efficiency. For example the coefficient of performance (COP) which is cooling capacity divided by work required calculated by (h1-h4)/(h2-h1). This calculates to be 77/9=8.5 a very high COP. A high COP indicates less work by the engine driving the compressor for a given cooling load. Although this actual COP may be lower due to compressor and mechanical efficiencies, the geothermal rejection temperature available can markedly reduce the energy and emissions for a given cooling load. Also the engine use time is markedly reduced.

Operation of the System in the Heating Mode:

The combination of geothermal loops with a heat pump driven by a co-generator makes for markedly greater fuel efficiency and thereby derived economic savings. The use of storage tanks to collect and store the energy allow for periodic use of the co-generator with extended useful life before required maintenance and overhaul. The geothermal loops provide the heat pump with a heat source temperature of typically 50 to 60 F, which is advantageous over normal ambient air temperatures especially in northern latitudes. The use of the I/C co-generator provides the economical power for the heat pump as compared to power grid energy.

In a typical heat pump in the heating mode, the output temperature for efficient operation is at about 110 F. This determines the operating temperature of the storage tank (5). Storage tank (6) receives rejected heat from the co-generator and is typically set at 150 F.

It is worth noting that 110 F is not considered adequate for normal space heating at northern latitudes. However supplementing this heat source with a 150 F source provides a very useful combination for space and tap water heating. FIG. (4) indicates one way of making use of these two temperatures with each storage tank having individual circulating loops to provide energy for space heating. The circulating fluid or air is first heated by the heat exchanger supplied by tank (5) and further heated by the heat exchanger supplied by storage tank (6).

Incoming water for the hot water tap is first heated by coils in the storage tank (5) and then by coils in storage tank (6). In this fashion energy is absorbed in an efficient mode. FIG. 4A shows refrigerant conditions and the reversal of the components eg. condenser relative to the space being serviced. This reversal is normally accomplished by controls and piping arrangements or a service call. FIG. 5 describes one possible system for accomplishing the seasonal change. The COP for heating is calculated by (h2-h3)/(h2-h1) or 67/6=11.2, a high value. Although the actual system COP will be lower due to mechanical and thermal efficiencies, the potential for marked energy savings is indicated. The heat being absorbed from the geothermal loop h1-h4 is a major contributor to the energy savings.

The above allows the achievement of major energy savings and emissions reduction. For a given heat load the engine energy and use time is thus markedly reduced making the use of a local co-generator practical.

A Design Use Example:

For example when the described is applied to heating a typical 2500 sq. ft. colonial home in New England, a 10 KW co-generator driving a 77000 Btu/hr GHP requires 27% operating time in the peak heating month. For the 8 month heating season the average operating time is only 15%. This results in approximately 60% fuel savings as compared to conventional furnace use. As important is that only approximately 900 hrs. of engine use is required. Typical small engine diesel life is now quoted as high as 10,000 hrs between overhauls.

The purpose of this patent is to describe how the combined benefits of GHP(geothermal/heat pump) with co-generation of power and use of heat storage tanks can provide major fuel and cost savings. It is not intended to show the many possible combinations of piping, heat exchanger arrangements, and controls that can be applied to the general arrangement described.

1: An energy delivery system used for space cooling or heating which includes a co-generator driven reversible geothermal connected heat pump, including at least two non-earth energy storage tanks where the cooling or heating output of the heat pump is delivered to a non-earth energy storage tank and where the waste heat of the co-generator is delivered to a second non-earth energy storage tank and where both storage tanks have means to deliver energy to the space being serviced and where the temperature of at least one of the storage tanks determines the start/stop cycles of the co-generator with the storage tanks containing sufficient storage media to markedly reduce the number of start/stop cycles required of the co-generator for delivering the required energy and where the use of a co-generator driven heat pump connected to a geothermal source allows a marked reduction in the duty cycle required of the co-generator.

2: An energy delivery system described in claim 1 where the co-generator includes an internal combustion engine.

3: An energy delivery system described in claim 1 where the co-generator is used to drive an electric generator which in turn is used to power the geothermal heat pump.

4: An energy delivery system described in claim 1 is used to supply heat for tap water in addition to space heat or cooling.

5: An energy delivery system described in claim 1 where the co-generator is mechanically coupled to drive the geothermal heat pump.

6: An energy delivery system described in claim 1 where the storage tanks store fluid and are equipped with means to supply heating or cooling to the space being serviced.

7: An energy delivery system described in claim 1 where the thermostats within the space being serviced control the circulating system deriving cooling or heating energy from the storage tanks.

8: An energy delivery system described in claim 1 when set to the space heating mode where the storage tank receiving fluid from the geothermal heat pump is set to a temperature to allow the heat pump operation at a coefficient of performance greater than 2.5.

9: An energy delivery system described in claim 1 where a third storage tank is added to store cold energy for cooling as compared to hot energy stored in the other tanks for heating.

10: An energy delivery system described in claim 3 where provision is provided for the electric generator to provide power to an electric heating element when the geothermal heat pump load is low or uncalled for but supplementary or tap water heating would be useful.

11: A method used for space cooling or heating which includes a co-generator driven reversible geothermal connected heat pump, including at least two non-earth energy storage tanks where the cooling or heating output of the heat pump is delivered to a non-earth energy storage tank and where the waste heat of the co-generator is delivered to a second non-earth energy storage tank and where both storage tanks have means to deliver energy to the space being serviced and where the temperature of at least one of the storage tanks determines the start/stop cycles of the co-generator with the storage tanks containing sufficient storage media to markedly reduce the number of start/stop cycles required of the co-generator for delivering the required energy and where the use of a co-generator driven heat pump connected to a geothermal source allows a marked reduction in the duty cycle required of the co-generator.

12: A method described in claim 11 that includes the heating of tap water by deriving heat from one or more of the non-earth storage tanks.

13: A method described in claim 11 where the energy storage tanks have means to deliver heating or cooling to the space being serviced.

14: A method described in claim 11 where the co-generator is an internal combustion engine driving an electric generator providing power for the geothermal heat pump.

15: A method described in claim 11 where the co-generator is an internal combustion engine directly driving the components of the geothermal heat pump.
